(19) United States
(12) Patent Application Publication
(10) Pub. No.: US 2021/0194964 A1
(43) Pub. Date: Jun. 24, 2021

(54) Method and Device for Transmitting and Receiving Measurement Values

(71) Applicant: Robert Bosch GmbH

(72) Inventor: Marlon Ramon Ewert, Untergruppenbach (DE)

(21) Appl. No.: 16/080,627

(22) PCT Filed: Feb. 22, 2017
(86) PCT No.: PCT/EP2017/054037

§ 371 Date: Aug. 28, 2018

(30) Foreign Application Priority Data
Mar. 3, 2016 (DE) 10 2016 203 515.0

(51) Int. Cl. H04L 29/08

(52) U.S. Cl. CPC H04L 67/12

(57) ABSTRACT

A method for transmitting a measurement value of a sensor includes mapping the measurement value from a first portion of a value range of the measurement value using a first mapping. The method further includes transmitting the measurement value to a data word. The sensor includes the value range of the measurement value.

### BACKGROUND INFORMATION

DE 101 49 332 A1 discloses a method for digital data transmission from a sensor to a control unit, in which the sensor values of the sensor are divided up according to different resolutions for the data transmission. The sensor values form a first value range having consecutive sensor values. The division of the first value range for the data transmission takes place as a function of a variable which is relevant to the control unit.

PSI5 is an open standard and supports the polling of up to four sensors per bus node, it being possible to poll said sensors in various configurations. Bidirectional communication for sensor configuration and diagnosis is also provided.

In airbag systems, for example, data from pressure or acceleration sensors is evaluated via current-modulated two-wire buses which communicate with the control unit via a Manchester-encoded protocol.

The possible operating modes are also established in the standard. First and foremost, these modes may be classified into synchronous and asynchronous operating modes. In the case of the synchronous operating modes, three operating modes result, depending on the interconnection of the sensors with the control unit: parallel bus mode (all sensors are connected in parallel), universal bus mode (serial interconnection of the sensors), and daisy-chain bus mode. Combined with other parameters, such as the total number of time slots, data rate, data word length, or parity/CRC monitoring, the PSI5 standard allows various implementation options. A data word length of 10 bits is widely used.

Currently deployed PSI5 sensors generally use a fixedly defined resolution for the measurement value of a sensor channel in a single communication slot. This fixedly defined resolution is generally constant for the entire detection range of the sensor.

The disadvantage of the previous practice is the necessary compromise between a high measurement value resolution and a broad measurement range. For example, current 10-bit sensors support either a high resolution with a low measurement range, or a high measurement range with low resolution. This is in particular counterproductive if the same sensor is used for different applications, wherein the measurement ranges and resolutions for the various applications fundamentally differ, and are thus incompatible with one another. This may in particular have a negative effect on the design of algorithms (for example, algorithms for triggering restraint means in airbag control units).

### SUMMARY OF THE INVENTION

Against this background, the present invention provides a method for transmitting measurement values of a sensor, in which the sensor has a value range of the measurement value, wherein a measurement value is mapped from a first portion of the value range of the measurement value for transmission to a data word.

This method is based on the finding that the entire value range of the measurement value detected by a sensor does not have to be used or is not usable for every application, for example, a method or an algorithm for controlling passenger protection means such as airbags and the like, which further processes a sensor value.

In order to utilize the available bandwidth for transmitting the sensor measurement values to the further-processing application in an optimal manner, it is advantageous to transmit only the portion of the value range of the measurement value which comprises the processable measurement values.

As a result, for example, the resolution of the transmitted sensor measurement value may be maintained to the greatest possible extent.

According to an advantageous embodiment of the method of the present invention, before the mapping, a first offset is applied to the measurement value from the first portion of the value range of the measurement value.

This embodiment is based on the finding that for certain applications, certain ranges of values of the measurement value experience a higher weighting. Thus, for example, it is conceivable that for methods for controlling passenger protection means, positive measurement values of an acceleration or pressure sensor have a higher weight than negative measurement values; thus, according to this embodiment of the present invention, it is advantageous to transmit a portion of the value range of the measurement value which is shifted into the positive region, instead of a portion of the value range of the measurement value which is arranged symmetrically about the zero point. In addition, it is suitable to provide the measurement value to be transmitted with a corresponding offset, so that the measurement value may be mapped in a simple manner to the value range of the data word used for transmission, which is typically arranged symmetrically about a zero value.

According to an advantageous embodiment of the method of the present invention, a measurement value from a second portion of the value range of the measurement value is mapped for transmission to the data word, wherein before the mapping, a second offset is applied to the measurement value from the second portion.

This embodiment is based on the idea of optimally utilizing the available bandwidth for transmitting the measurement value, in that unused portion of the value range of the data word used for transmission is populated with a portion of the value range of the measurement value which otherwise would have exceeded the maximum or minimum transmittable value.

This embodiment of the method develops a particular potential if the first portion of the value range of the measurement value is not populated with an offset before the mapping to the data word, since populating with an offset assumes addition or a subtraction. In particular in the binary range, addition and subtraction are resource-intensive operations. This operation may be dispensed with, at least for the measurement values from this first portion of the value range of the measurement value.

According to an advantageous embodiment of the method of the present invention, the mapping to the data word is a proportional mapping.

This embodiment is based on the idea that a proportional mapping constitutes a simple function which can be implemented in an economical manner. For example, via a correspondingly configured application-specific integrated circuit (ASIC).

An additional aspect of the present invention is a method for receiving measurement values of a sensor, in which a measurement value for further processing may be ascertained from the received data word by means of a second mapping.

This aspect of the present invention is based on the idea that the sensor value transmitted by means of the data word does not exist in an optimal form for every further-processing application. Therefore, it is advantageous to provide a received data word for further processing by means of a corresponding mapping.

According to an advantageous embodiment of the method of the present invention, the second mapping is an inverse mapping with respect to the first mapping.

This embodiment is based on the idea that a sensor measurement value, which was transmitted by means of the method according to the present invention for transmitting measurement values of a sensor, is mapped having a correspondingly inverse mapping for the further processing. This has the advantage that the value range of the measurement value of the sensor may be provided for the further-processing application. This is important if the further-processing control unit processes different sensor inputs, and therefore, non-transmission-specific depiction variants of the transmitted sensor measurement value must be taken into account. As a result, a more flexible use of the transmission and reception methods and the sensors according to the present invention is possible.

According to another advantageous embodiment of the present invention, a third offset corresponding to the first offset is applied to the ascertained measurement value.

This embodiment of the present invention has the advantage that the value which was transmitted by means of the data word is transformed back to the zero point of the detecting sensor. This results in simplified further processing of the transmitted sensor measurement value, since the optimization in the further-processing applications which was made for the transmission no longer have to be taken into account.

According to an advantageous embodiment of the method of the present invention, the data word originates from a data word value range, wherein a fourth offset which corresponds to the second offset is applied to the ascertained measurement value if the data word lies in a first portion of the data word value range.

This embodiment of the present invention has the advantage that sensor measurement values which were transformed by means of the second offset, for transmission to the one typically unused or irrelevant range of the data word value range, are now again transformed back to their original point. Here as well, it is advantageous that the optimizations which were carried out for transmitting the sensor measurement value do not have to be taken into account in further-processing applications.

According to an advantageous embodiment of the method of the present invention for reception, the measurement value is transmitted by means of a variant of the method for transmitting measurement values of a sensor according to the present invention.

The present invention provides the greatest use in interaction with the method presented for transmitting a measurement value of a sensor, and the method presented for reception. By means of this interaction, the data word width, or rather, the bandwidth which is available for transmission, may be optimally utilized, and a loss in quality, or rather, a loss of information due to the transmission is minimized.

Another aspect of the present invention is a sensor which is configured so as to carry out all steps of an embodiment of the method of the present invention for transmitting a measurement value.

According to a preferred embodiment of the sensor of the present invention, at least one function for mapping measurement values to data words is stored in the sensor.

By storing at least one function for mapping sensor measurement values to data words in the sensor, additional application complexity is dispensed with. A corresponding sensor must be ready to transmit sensor measurement values in an optimal manner immediately after start-up.

According to an advantageous embodiment of the sensor of the present invention, in an initialization phase, the sensor transmits the functionality, which is selected for mapping, of the at least one stored function.

By means of this variant of the sensor, it is simple to set up the system in which the sensor is incorporated. The sensor provides its configuration, i.e., the functionality selected for transmission, and the point provided for reception, typically a control unit, can accordingly set itself up, or rather configure itself.

Transmitting the selected functionality is to be understood below to mean that the sensor transmits the selected functionality in the form of a suitable depiction as a function. It is likewise conceivable that an arrangement exists between the sensor and the point provided for reception such that it is sufficient that the sensor transmits a corresponding identification code which sufficiently characterizes the selected functionality for the receiving point.

An additional aspect of the present invention is a receiving device, in particular a control unit, which is configured so as to carry out all steps of an embodiment of the method of the present invention for receiving measurement values.

According to an advantageous embodiment of the control unit of the present invention, the control unit is suitable for receiving measurement values of a sensor according to the present invention.

Another aspect of the present invention is a computer program which is configured so as to carry out all steps of an embodiment of the methods of the present invention.

Another aspect of the present invention is a machine-readable storage medium on which the computer program of the present invention is stored.

Selected variants, or rather advantageous embodiments of the present invention, will be described in greater detail below using figures.

The following are shown:

FIG. 1 shows a linear mapping of sensor measurement values to data words of a 10-bit communication slot of the PSI5 protocol;

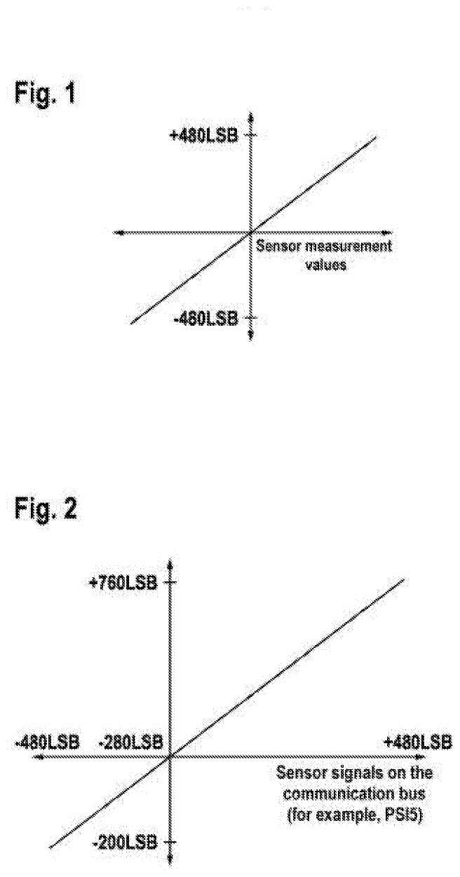

FIG. 2 shows an asymmetrical mapping of data words to sensor measurement values;

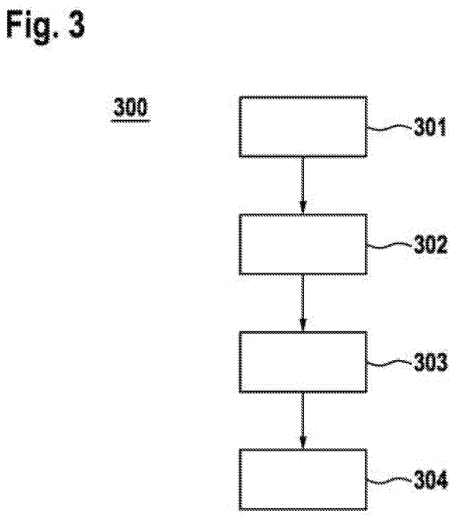

FIG. 3 shows a flow chart of an embodiment of the method for transmission;

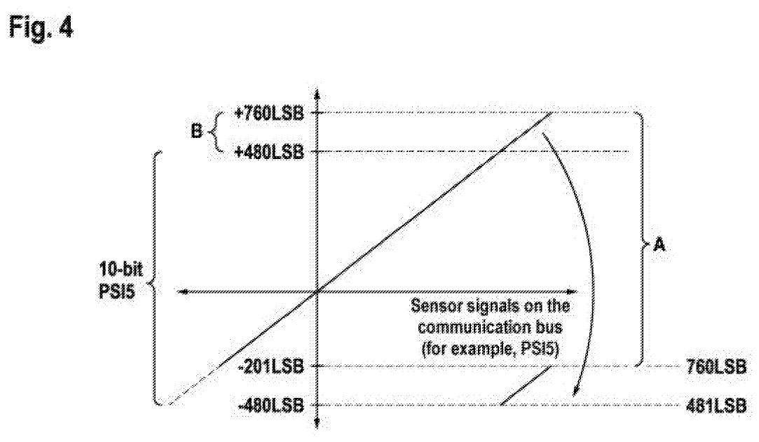

FIG. 4 shows an alternative asymmetrical mapping of data words to sensor measurement values;

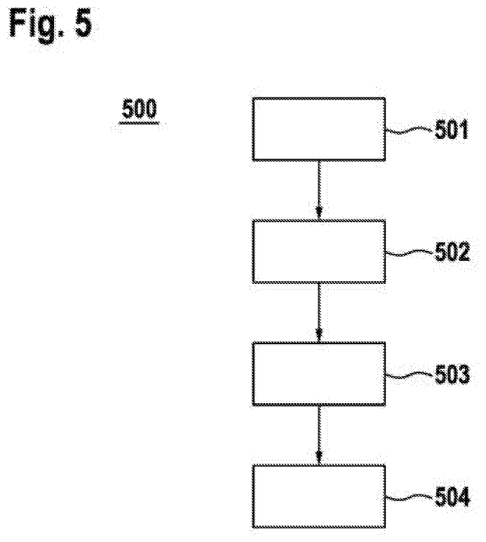

FIG. 5 shows a flow chart of an embodiment of the method for transmission.

FIG. 1 shows a linear mapping of sensor measurement values to data words of a 10-bit communication slot of the PSI5 protocol, according to the prior art.

The sensor measurement values are plotted on the abscissa. The values of the data word of the 10-bit communication slot are plotted on the ordinate. If 10-bit integer values which are symmetrically encoded about the zero point are available, the value range according to the PSI5 standard extends from −480 LSB, across 0 LSB, to +480 LSB.

The straight line is intended to depict the linear mapping of the sensor measurement values to the data word.

Modern sensors which transmit their measurement values according to the PSI5 protocol generally use a fixedly defined resolution for the measurement value of a sensor channel in a single communication slot. This fixedly defined resolution is generally constant for the entire sensing range of the sensor. This means, for example, that the data range of a 10-bit sensor is sufficient for a sensor channel according to the mapping in FIG. 1 of −480 LSB to +480 LSB.

The disadvantage is the required compromise between a high measurement value resolution and a wide measurement range. For example, a modern 10-bit sensor supports either a high resolution with a low measurement range, or a wide measurement range with low resolution.

Preferred embodiments of the present invention will be provided below, based on transmission by means of the PISS protocol, using a 10-bit data word per communication slot.

In the first preferred embodiment, the measurement range expansion of the sensor takes place by shifting the zero point of the sensor measurement values on the communication bus.

FIG. 2 shows an asymmetrical mapping of 10-bit data words to sensor measurement values with uniform resolution, with the aid of a zero-point shift according to this preferred embodiment.

The values of the data word of the 10-bit communication slot are plotted on the abscissa. Sensor measurement values are plotted on the ordinate. The straight line which is drawn in depicts the mapping of the sensor measurement value to a data word for transmission.

A simple way to achieve a mapping according to FIG. 2 is to initially provide the sensor measurement values of the sensor with an offset, before the transmission to the communication bus. This offset corresponds to shifting the zero point of the sensor signals in this example by −280 LSB.

This means, for example, that the sensor signal value of 0 LSB is now mapped to the data word value of −280 LSB, while, for example, the sensor measurement value of +760 LSB is mapped to the data word value of +480 LSB, and the sensor measurement value of −200 LSB sensor measurement value is mapped to the data word value of −480 LSB. The result is that during the transmission, the signals also continue to be transmitted in a range of +/−480 LSB, as depicted in FIG. 1. However, during the transmission, the signals are encoded differently, as described based on the zero-point shift. In this way, a measurement range expansion of the sensor in a positive measurement direction is achieved, since this measurement direction is more important in this example, while the measurement range of the sensor in a negative measurement direction is limited to −200 LSB.

It is clear that such a measurement range expansion can also similarly favor the negative value range of the measurement value of a sensor.

In a simple implementation, the zero-point shift may be encoded with the aid of a mathematical function, or rather with the aid of case differentiation, so that the mapping of the sensor measurement values to the sensor signals of the communication bus is calculated in an automated manner, depending on the sensor measurement value.

In this case, the calculation may take place either in software on the sensor, or via logic within an application-specific integrated circuit (ASIC) of the sensor. Subsequently, a transmission of the sensor signals calculated from the sensor measurement values takes place on the bus.

FIG. 3 shows a flow chart of the aforementioned embodiment of a method according to the present invention for transmitting measurement values of a sensor.

In step 301, the sensor measurement values from −200 LSB to +760 LSB are recalculated to data word values between −480 LSB and +480 LSB by means of a zero-point shift of the sensor measurement values. The zero-point shift takes place by applying a first offset of −280 LSB. This first offset is suitable for the selected portion of the value range of the measurement value and the available data word width. It is clear that when choosing another portion of the value range of the measurement value, or in the case of another available data word width, a correspondingly different offset is to be chosen.

In step 302, the recalculated data word value is transmitted via the sensor by means of a communication bus, for example, according to the PSI5 protocol.

In step 303, the recalculated data word value is received and processed in the receiver, presently, for example, in the control unit.

In step 304, the recalculated data word value is back-calculated in the control unit from the value range between −480 LSB and +480 LSB, so that the transmitted sensor measurement value is correctly interpreted in the control unit. In addition, within the scope of the present invention, an inverse recalculation of the transmitted data word values takes place. For this purpose, the zero-point shift is stored by the sensor in the control unit as a mathematical function. In the present example, in the control unit, in addition, an offset corresponding to the first offset, for example, in the present example, +280 LSB, is applied to the transmitted data word value. As a result, the data word value is again back-calculated to a sensor measurement value between −200 LSB and +760 LSB. In addition, it is conceivable that the received sensor measurement value is scaled to the requirements of the subsequent processing application.

A second preferred embodiment is provided below, which would manage without a zero-point shift.

According to this embodiment, the measurement range expansion of the sensor takes place by encoding the sensor measurement values outside the transmission range to unused ranges on the communication bus.

FIG. 4 shows the corresponding asymmetrical mapping of 10-bit data words to sensor measurement values with uniform resolution by means of utilizing otherwise unused data word value ranges.

The values of the data word of the 10-bit communication slot are plotted on the abscissa. Sensor measurement values are plotted on the ordinate. The straight line which is drawn in depicts the mapping of the sensor measurement value to a data word for transmission.

In FIG. 4, the portion of the sensor measurement value range which is provided for transmission is indicated by A. Furthermore, FIG. 4 shows a second range B, which extends beyond the range which is transmittable by means of the data word provided for transmission. Furthermore, it is apparent from FIG. 4 that free values are present in the negative value range of the data word. According to the embodiment described here, these free values are used to transmit the values in the excess positive range B.

In FIG. 4, the sensor measurement values of the sensor which are located outside the transmission range of the communication are initially encoded before the transmission to unused ranges of the communication bus. According to the depiction in FIG. 4, this encoding corresponds to a flipping of the sensor measurement values between +481 LSB and +760 LSB into the unused negative range of the communication bus between −480 LSB and −201 LSB. This means, for example, that the sensor measurement value of 0 LSB continues to be mapped to the data word value of 0 LSB, while, for example, the sensor measurement value of +760 LSB is mapped to the data word value of −201 LSB of the communication bus, and the sensor measurement value of +481 LSB is mapped to the data word value of −480 LSB. This means that the signals continue to be transmitted in a data word value range of +/−480 LSB according to FIG. 1. However, during the transmission, the signals are encoded differently, as described. In this way, a measurement range expansion of the sensor in a positive measurement direction may be achieved, since this measurement direction is more important in this example, while the measurement range of the sensor in a negative measurement direction is limited to −200 LSB.

A particular advantage of this embodiment is that an offset does not have to be applied to sensor measurement values in a first range about the zero point, before the mapping to a data word. This advantageously saves a calculation step. According to the described embodiment for encoding in the unused negative value range of the data word, a corresponding offset is applied only to particularly high measurement values, in the provided example, those measurement values which are mapped to data word values above +480 LSB.

It is understood that according to this embodiment, sensor measurement values which would be mapped to a data word value between −201 SB and −480 LSB if no offset is applied, would not be transmitted by means of this embodiment. However, this is thus provided in order to expand the transmitted value range into a predetermined positive range of the sensor measurement values.

It is understood that, depending on the application, a correspondingly mirrored application would be possible if the value range of the measurement value of the sensor which is provided for transmission is to be expanded into the negative range.

In a simple implementation, the encoding of the sensor measurement values may be carried out with the aid of a mathematical function, or rather, with the aid of case differentiation, so that the mapping of the sensor measurement values to the sensor signals of the communication bus is calculated in an automated manner, depending on the sensor measurement value.

In this case, the calculation takes place either in software on the sensor, or via logic within an application-specific integrated circuit (ASIC) of the sensor. Subsequently, the sensor signals calculated from the sensor measurement values are transmitted to the bus.

FIG. 5 shows a flow chart of the aforementioned embodiment of a method according to the present invention for transmitting measurement values of a sensor.

In step 501, in the sensor, the sensor measurement values from −200 LSB to +760 LSB are mapped to data word values between −480 LSB and +480 LSB by flipping the sensor measurement values between +481 LSB and +760 LSB into the unused negative data word value range between −480 LSB and −201 LSB.

In one possible implementation, the flipping may take place by applying a second offset of presently −961 LSB. This second offset is suitable for the selected portion of the value range of the measurement value and the available data word width. It is clear that when choosing another portion of the value range of the measurement value, and in the case of another available data word width, a correspondingly different offset is to be chosen. Likewise, it is clear that in the case of a combination of the aforementioned embodiment with the embodiment according to FIGS. 2 and 3, a correspondingly adapted second offset is to be chosen with the corresponding first offset.

In step 502, the recalculated data word value is transmitted via the sensor by means of a communication bus, for example, according to the PSI5 protocol.

In step 503, the recalculated data word value is received and processed in the receiver, presently, for example, in the control unit.

In step 504, the recalculated data word value is back-calculated in the control unit from the value range between −480 LSB and +480 LSB, so that the transmitted sensor measurement value is correctly interpreted in the control unit. For this purpose, within the scope of the present invention, an inverse conversion of the transmitted data word value takes place. For this purpose, the inverse flipping is stored in the control unit as a mathematical function. In the present example, in the control unit, in addition, a fourth offset corresponding to the second offset, for example, in the present example, +961 LSB, is applied to the transmitted data word values which were shifted into the unused, in the present case, negative, data word value range, via the “flipping” in the sensor. As a result, the transmitted data word value is again back-calculated to a sensor measurement value between −200 LSB and +760 LSB. In addition, it is conceivable that the received sensor measurement value is scaled to requirements of the subsequent processing application.

1. A method for transmitting a measurement value of a sensor, the sensor including a value range of the measurement value, the method comprising:
mapping the measurement value from a first portion of the value range of the measurement value using a first mapping; and
transmitting the measurement value to a data word.

2. The method as claimed in claim 1, further comprising:
applying a first offset to the measurement value from the first portion of the value range of the measurement value before the mapping.

3. The method as claimed in claim 1, further comprising:
mapping the measurement value from a second portion) of the value range of the measurement value; and
applying a second offset to the measurement value from the second portion before the mapping.

4. The method as claimed in claim 1, wherein the first mapping to the data word is a proportional mapping.

5. A method for receiving a measurement value of a sensor, comprising:
receiving a data word; and
ascertaining the measurement value for further processing from the received data word using a mapping.

6. The method as claimed in claim 5, wherein:
the data word is transmitted by mapping the measurement value from a first portion of the value range of the measurement value using another mapping, the sensor includes a value range of the measurement value, and the mapping is an inverse mapping with respect to the another first mapping.

7. The method as claimed in claim 6, further comprising:
applying an offset corresponding to another offset to the ascertained measurement value.

8. The method as claimed in claim 6, further comprising:
originating the data word from a data word value range; and
applying an offset corresponding to another offset to the ascertained measurement value if the data word lies in the first portion of the data word value range.

9. A sensor, comprising:
a microcontroller configured to transmit a measurement value of the sensor by:
mapping the measurement value from a first portion of a value range of the measurement value using a first mapping, and
transmitting the measurement value to a data word,
wherein the sensor includes the value range of the measurement value.

10. The sensor as claimed in claim 9, wherein at least one function for the mapping is stored in the sensor.

11. The sensor as claimed in claim 10, wherein the microcontroller is further configured to:
transmit the functionality, which is selected for mapping, of the at least one stored function in an initialization phase.

12. The method as claimed in claim 5, wherein a control unit is configured to perform the method.

13. The method as claimed in claim 12, wherein the control unit is configured to receive the data words from the sensor.

14. The sensor as claimed in claim 9, wherein at least one function is stored in the sensor during manufacture of the sensor.

15. The method as claimed in claim 1, wherein a computer program is configured to carry out the method.

16. The method as claimed in claim 15, wherein the computer program is stored on a machine-readable storage medium.
